(19) United States
(12) Patent Application Publication
(10) Pub. No.: US 2008/0059494 A1
(43) Pub. Date: Mar. 6, 2008

(54) Document database system and method

(76) Inventors: Ean Rouse Schuessler, Dallas, TX (US); Erik Alexander Schuessler, Dallas, TX (US)

Correspondence Address: Mr. Christopher John Rourk;Jackson Walker LLP, 901 Main Street, Suite 6000, DALLAS, TX, 75202, US

(21) Appl. No.: 11/515,157

(22) Filed: Sep. 1, 2006

(51) Int. Cl. G06F 7/00

(52) U.S. Cl. 707/100

(57) ABSTRACT

A document database system is provided. The document database system includes a database creation system receiving a document having one or more defined fields and generating a database structure for storing data associated with the fields and a document identifier. A form publication system receives user-entered data associated with the defined fields in the document and publishes the document with a machine readable unique document identifier. An executed document processing system receives an image data file of an executed copy of the published document, reads the machine readable unique document identifier and stores the document in the database structure.

### CLAIM OF PRIORITY

None

### FIELD OF THE INVENTION

The present invention relates to database architectures, and more particularly to an improved database architecture for generating and receiving documents that require execution.

### BACKGROUND OF THE INVENTION

Presently, database systems for handling executed documents require a user to code each document when it is received. For example, document management systems allow documents to be stored using predetermined fields, but those fields must still be selected by the user. Even the act of retrieving a document from an email or fax server requires some amount of human activity. As such, the cost for document handling is directly proportional to the number of documents received.

### SUMMARY OF INVENTION

The present invention achieves technical advantages as a document database system and method that allow executed documents to be readily processed and stored without human intervention, so as to eliminate the need for manual processing of executed documents.

### BRIEF DESCRIPTION OF THE SEVERAL VIEWS OF THE DRAWINGS

FIG. 1 is a diagram of a document database system in accordance with an exemplary embodiment of the present invention; and

FIG. 2 is a diagram of a method for document database management in accordance with an exemplary embodiment of the present invention.

### DETAILED DESCRIPTION OF THE PRESENT INVENTION

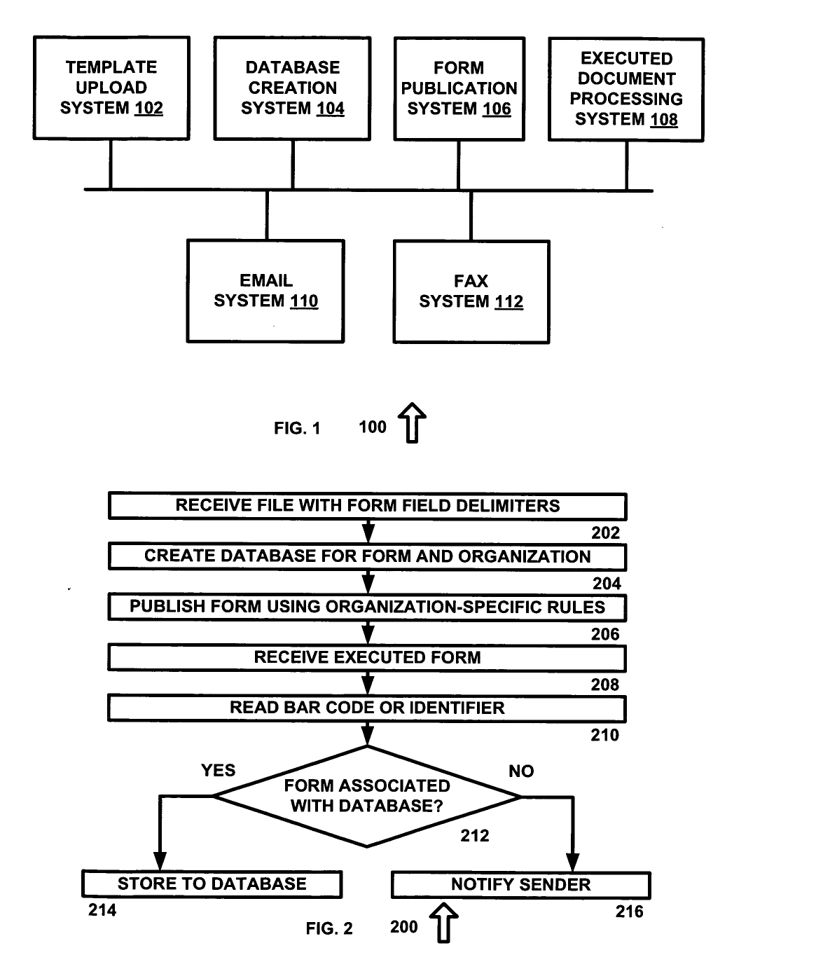

FIG. 1 is a diagram of a document database system 100 in accordance with an exemplary embodiment of the present invention. Document database system 100 includes template upload system 102, database creation system 104, form publication system 106, executed document processing system 108, email system 110 and fax system 112, each of which are coupled by a network or other suitable communications media and which can be implement in hardware, software, or a suitable combination of hardware and software, and which can be one or more software systems operating on a general purpose operating system.

As used herein, the term “couple” and its cognate terms such as “coupled” and “couples” can include a physical connection (such as a shaft coupling or electrical conductor), a virtual connection (such as through one or more randomly assigned memory locations of a data processing systems), a logical connection (such as through one or more logical devices), or other suitable connections or combinations of connections.

As used herein, a hardware system can include discrete semiconductor devices, an application-specific integrated circuit, a field programmable gate array, a general purpose processing platform, or other suitable devices. A software system can include one or more objects, agents, threads, lines of code, subroutines, separate software applications, user-readable (source) code, machine-readable (object) code, two or more lines of code in two or more corresponding software applications, databases, or other suitable software architectures. In one exemplary embodiment, a software system can include one or more lines of code in a general purpose software application, such as an operating system, and one or more lines of code in a specific purpose software application.

Template upload system 102 allows a user to define a template form for use with document database system 100. In one exemplary embodiment, template upload system 102 allows a user to create a form and specify one or more fields on the form that should be stored in a database and associated with an executed form. In one exemplary embodiment, template upload system 102 allows a user to identify predetermined user-selectable entries for each form field, and does not allow a user to add entries other than those that are user-selected, such as to allow the user to fill out the form in a manner that associates the form entries with the form prior to execution. Likewise, other suitable processes can also or alternatively be used, such as allowing users to manually write in field entries and scanning the field entries using optical character recognition, by storing field entries after they are typed in by the user, or in other suitable manners.

Database creation system 104 receives a template from template upload system 102 and creates a database for executed documents associated with the template. In one exemplary embodiment, database creation system 104 associates the template with the organization using the template, such as to assign organization-specific data to the template, such as file numbers, contact data, price data, or other suitable data.

Form publication system 106 publishes forms, such as on a website, by faxing or mailing the forms, or in other suitable manners. Form publication system 106 allows an organization to make forms available to users, such as by filling the form using a web-enabled graphic user interface, to print off the forms, and to then execute the forms for return and processing by document database system 100. In one exemplary embodiment, form publication system 106 includes a bar code or other identification field on the form that allows the form to be identified when it is returned, so as to be associated with the user-selected data and the organization.

Executed document processing system 108 allows an executed document to be processed after it is received via fax, email, scanning or otherwise in electronic form. In one exemplary embodiment, executed document processing system 108 can receive an image data file and identify a bar code or other image data that allows executed document processing system 108 to identify the document, field data that was entered for the document, the organization associated with the document, and to perform other suitable processes, such as storing the document in a database so as to allow it to be retrieved upon demand, generating other documents or performing other processes such as generating email notifications to users to allow them to take additional actions in response to receipt of the executed document (such as verification or execution), or other suitable processes. In one exemplary embodiment, a handwriting recognition program can be used to determine whether the document has been executed, so as to eliminate the need for manual verification.

Email system 110 and fax system 112 allow executed documents to be transmitted to executed document processing system 108 after they have been executed. In one exemplary embodiment, documents in digital form are addressed to executed document processing system 108, such as using an email address, a fax telephone number, or in other suitable manners.

In operation, system 100 allows forms to be generated and databases to automatically associated with the forms, so as to eliminate the need to manually structure a database for each form. In this manner, a user can generate a form and system 100 will then automate the creation of a database, publication of the form, and receipt and storage of the executed form, so as to allow documents that require execution to be generated and processed without manual activity.

FIG. 2 is a diagram of a method 200 for document database management in accordance with an exemplary embodiment of the present invention. Method 200 begins at 202, where a file is received with form delimiters. In one exemplary embodiment, the file can be a Microsoft Word format file with field delimiters or other suitable word processing files. The file can also be generated using a graphic user interface, with predetermined allowable field entries for a pull-down menu, or in other suitable manners. The method then proceeds to 204.

At 204, a database is created for the form, the organization, and other suitable data. In one exemplary embodiment, a user can submit the form and create additional account data that identifies the organization, additional processes to be performed after the completed form is received, publication processes, and other suitable account data. The database can be created to store fields, generated periodic reports, allow certain users to access or search the database, or for other suitable purposes. The method then proceeds to 206.

At 206, the form is published using organization-specific rules. In one exemplary embodiment, the user can be required to fill a form out before being allowed to print the form off, can be required to submit payment, can be required to submit identification, or can otherwise be required to perform predetermined tasks. Likewise, the form can be made available through a website, by email, by facsimile, or in other suitable manners. The method then proceeds to 208.

At 208, the executed form is received, such as by email, facsimile, scanning, or in other suitable manners. The method then proceeds to 210 where a bar code or other identifier is read from the form. In one exemplary embodiment, the bar code or other identifier can be located in a predetermined location and image processing can be used to identify a user, organization, or other data associated with the document. The method then proceeds to 212.

At 212, it is determined whether the form is associated with a database, such as to determine whether the form has been modified, whether the database is still active, or for other suitable purposes. If it is determined that the form is not associated with a database, the method proceeds to 216 and the sender is notified. Otherwise, the method proceeds to 214 and the form is stored to the associated database. Additional workflow processes can also be performed.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A document database system comprising:
a database creation system receiving a document having one or more defined fields and generating a database structure for storing data associated with the fields and a document identifier;
a form publication system receiving user-entered data associated with the defined fields in the document and publishing the document with a machine readable unique document identifier; and
an executed document processing system receiving an image data file of an executed copy of the published document, reading the machine readable unique document identifier and storing the document in the database structure.
